(19) United States
(12) Patent Application Publication
(10) Pub. No.: US 2015/0145363 A1
(43) Pub. Date: May 28, 2015

(54) MAGNETIC WHEEL BEARING

(71) Applicant: Schaeffler Technologies AG & Co. KG, Herzogenaurach (DE)

(72) Inventors: Yohannes Haile, Canton, MI (US); Shakeel Shaikh, Windsor (CA); Bogyu Kang, Troy, MI (US); Karen Flores De Jesus, Troy, MI (US); Zheng Wang, Rochester Hills, MI (US)

(73) Assignee: SCHAEFFLER TECHNOLOGIES AG & CO. KG, Herzogenaurach (DE)

(21) Appl. No.: 14/595,957

(22) Filed: Jan. 13, 2015

(51) Int. Cl. B60B 27/02; F16C 32/04

(52) U.S. Cl. CPC B60B 27/02; F16C 32/0474; B60B 2380/22
USPC 310/90.5

(57) ABSTRACT

An active magnetic wheel bearing including at least two electromagnetic units arranged to support a wheel hub flange of a vehicle within a bearing outer ring. The active magnetic wheel bearing requires little change to surrounding known structure of the wheel hub flange unit. In addition a method of control and operation of the magnetic wheel bearing is presented.

### TECHNICAL FIELD

The present disclosure relates to an active magnetic bearing, in particular an active magnetic bearing for a vehicular wheel application and a method of controlling an active magnetic wheel bearing.

### BACKGROUND

Magnetic bearings are known, for example in U.S. Pat. No. 5,300,843 and U.S. Pat. No. 4,920,290. Magnetic bearings operate and support loads by using electromagnetic levitation, for instance, by using electromagnetic forces to levitate a rotating shaft in three dimensional space. A current flow is supplied to electromagnets distributed around an inner circumferential space of the bearing, generating magnetic fields that support shafts or other rotating objects, and are maintained in position by actively controlling the electromagnets, leaving no contact between the bearing and the rotating object or mass.

Wheel bearing applications are also known in the art. For example, prior art wheel bearings include an inner ring, outer ring and rolling elements between the rings, integrally assembled on a wheel hub and mounted to a vehicle using a suspension member or knuckle arrangement known in the art. Wheel bearings can also be made as a separate unitary assembly that is assembled onto an outer diameter of a wheel hub, and fixed onto the assembly by a variety of methods known in the art, including a press fit.

### SUMMARY

According to aspects illustrated herein, there is provided a magnetic bearing which includes; an axis; a wheel hub flange arranged to connect to a wheel, including a flange with a radial face directed toward a wheel and a cylindrical hub extending axially from a flange and arranged to connect to a vehicle wheel shaft; an electromagnetic modification unit fixedly assembled onto outer an cylindrical surface of the cylindrical hub, including a first axial end having a hollow cylindrical shape, a second axial end having a hollow cylindrical shape and an integrally formed axial position disc extending radially outward from a second axial end and having first and second radial faces; an outer ring axially aligned with the electromagnetic modification unit to form a gap there between, including a first axial end axially aligned with first axial end of electromagnetic modification unit, second axial end axially aligned with second axial end of electromagnetic modification unit and wheel knuckle mounting feature arranged to connect to a wheel knuckle; first electromagnetic unit fixedly assembled at first axial end of outer ring and arranged to magnetically levitate first axial end of the electromagnetic modification unit in radial space; and a second electromagnetic unit fixedly assembled at the second axial end of the outer ring, radially aligned with the axial position disc of electromagnetic modification unit 6 and arranged to magnetically levitate second axial end 22 of the electromagnetic modification unit in axial space. The magnetic bearing is capable of providing controllable radial, axial and moment load support to meet desired applications requirements.

According to aspects illustrated herein, there is provided a method of operating a magnetic wheel bearing.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a cylindrical coordinate system demonstrating spatial terminology used in the present application;

FIG. 2 is a cross sectional view of an active magnetic wheel bearing according to one example embodiment;

FIG. 3 is a schematic view of a control system for an active magnetic wheel bearing according to one example embodiment;

FIG. 4 is a a schematic view of a control system for an active magnetic wheel bearing according to a second example embodiment;

FIG. 5 is a schematic view of a control system for an active magnetic wheel bearing according to a third example embodiment;

FIG. 6 a schematic view of a control system for an active magnetic wheel bearing according to a fourth example embodiment.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

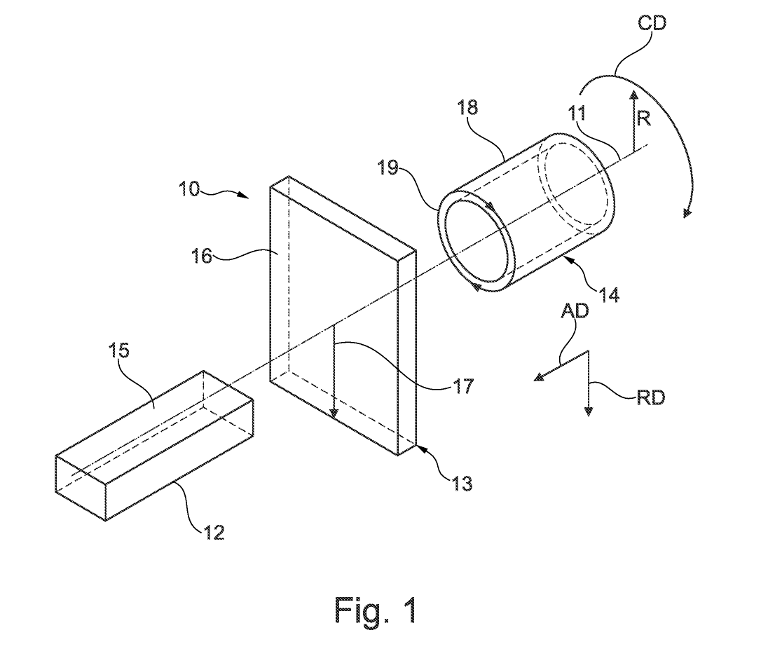

FIG. 1 is a perspective view of cylindrical coordinate system 10 demonstrating spatial terminology used in the present application. The present application is at least partially described within the context of a cylindrical coordinate system. System 10 includes longitudinal axis 11, used as the reference for the directional and spatial terms that follow. Axial direction AD is parallel to axis 11. Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane co-planar with axis 11. Axis 11 passes through planar surface 15; however any planar surface co-planar with axis 11 is an axial surface. A radial surface, such as surface 16 of object 13, is formed by a plane orthogonal to axis 11 and co-planar with a radius, for example, radius 17. Radius 17 passes through planar surface 16; however any planar surface co-planar with radius 17 is a radial surface. Surface 18 of object 14 forms a circumferential, or cylindrical, surface. For example, circumference 19 passes through surface 18. As a further example, axial movement is parallel to axis 11, radial movement is orthogonal to axis 11, and circumferential movement is parallel to circumference 19. Rotational movement is with respect to axis 11. The adverbs “axially,” “radially,” and “circumferentially” refer to orientations parallel to axis 11, radius 17, and circumference 19, respectively. For example, an axially disposed surface or edge extends in direction AD, a radially disposed surface or edge extends in direction R, and a circumferentially disposed surface or edge extends in direction CD.

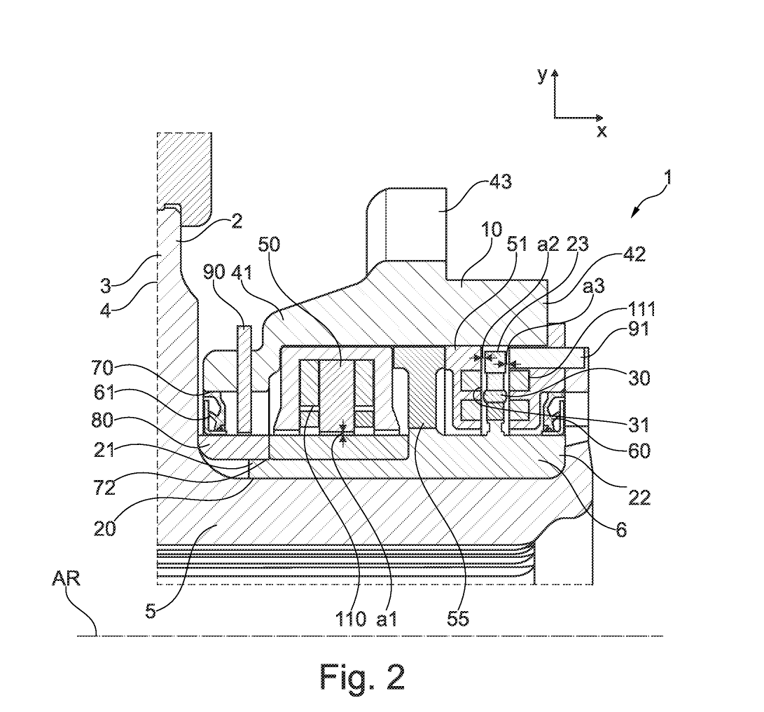

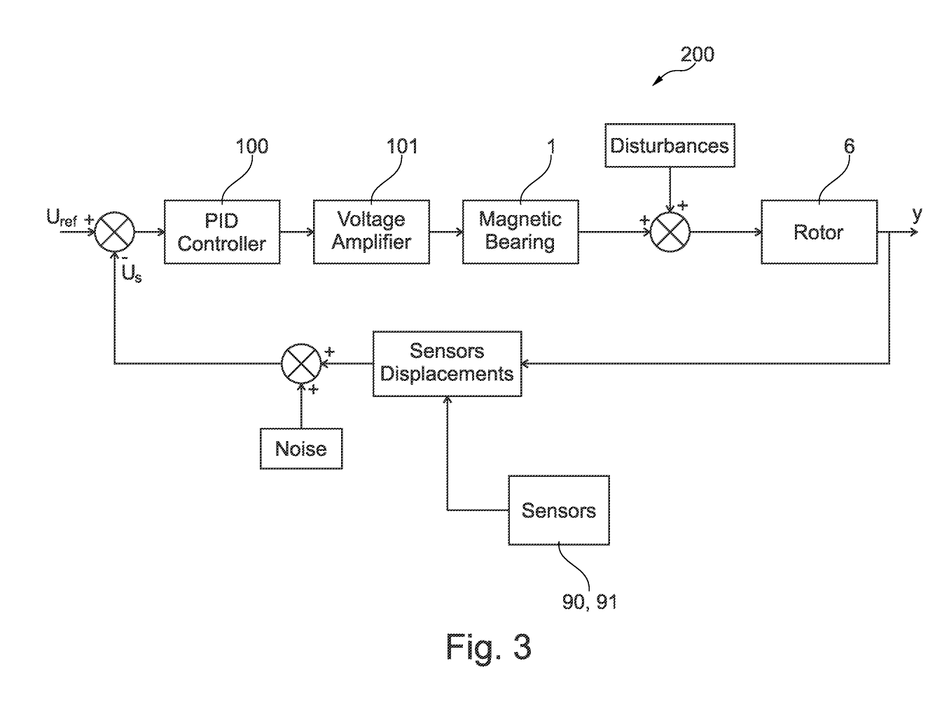

FIG. 2 is a cross sectional view of active magnetic wheel bearing 1 according to one example embodiment. Magnetic bearing 1 includes; axis AR; wheel hub flange 2 arranged to connect to a wheel (not shown), including flange 3 with radial face 4 directed toward a wheel (not shown) and cylindrical hub 5 extending axially from flange 3 and arranged to connect to a vehicle wheel shaft (not shown); electromagnetic modification unit 6 fixedly assembled onto outer cylindrical surface 20 of the cylindrical hub 5, including first axial end 21 having a hollow cylindrical shape, second axial end 22 having a hollow cylindrical shape and integrally formed axial position disc 23 extending radially outward from second axial end 22 and having first and second radial faces 30,31; outer ring 10 axially aligned with electromagnetic modification unit 6 to form a gap therebetween, including first axial end 41 axially aligned with first axial end 21 of electromagnetic modification unit 6, second axial end 42 axially aligned with second axial end 22 of electromagnetic modification unit 6 and wheel knuckle mounting feature 43 arranged to connect to a wheel knuckle (not shown); first electromagnetic unit 50 fixedly assembled at first axial end 41 of outer ring 10 and arranged to magnetically levitate first axial end 21 of electromagnetic modification unit 6 in radial space; and second electromagnetic unit 51 fixedly assembled at second axial end 42 of outer ring 10, radially aligned with axial position disc 23 of electromagnetic modification unit 6 and arranged to magnetically levitate second axial end 22 of electromagnetic modification unit 6 in axial space. Magnetic bearing 1 is capable of providing controllable radial, axial and moment load support to meet desired applications requirements. For clarity electromagnetic modification unit 6 is also termed a rotor in magnetic bearing 1, in particular in the control diagrams of FIGS. 3-6.

In addition, according to the example embodiment emergency support element 55 is positioned axially between electromagnetic units 50, 51 and radially positioned outer ring 10 and between electromagnetic modification unit 6, such that if either or both electromagnetic units 50, 51 fail or do not operate properly, cylindrical hub 5 will remain supported and axially and radially aligned within outer ring 10. Emergency support element 55 may be a plain bearing, roller bearing or any other support element known in the art. Seals 60, 61 can also be used at opposite axial ends of outer ring 10. In the example embodiment, seals 60, 61 are pressed on inner cylindrical surface 70 of outer ring 10 and outer cylindrical surface 72 of modification unit 6. Alternatively seals can be pressed on mating components to outer ring 10 and unit 6, for example electromagnetic unit 51 at second axial end 42 and spacer 80 at first axial end 41.

In order to properly locate unit 6 and associated wheel hub flange 2 in a desired reference position, at least one radial position sensor 90 and one axial position sensor 91. In the example embodiment of FIG. 2, first radial position sensor 90 is fixedly assembled at first axial end 21 and arranged to sense radial position, y, of electromagnetic modification unit 6 and first axial position sensor 91 is fixedly assembled at second axial end 22 of electromagnetic modification unit 6 to sense axial position, x, of electromagnetic modification unit 6. To improve radial and axial position monitoring, it will be understood by one skilled in the art that multiple radial and axial position sensors 90, 91 may be used and circumferentially distributed around electromagnetic modification unit 6.

Electromagnetic modification unit 6 is needed to avoid changes to the form of wheel hub flange 2 and to provide a proper magnetic field support for electromagnetic units 50,51. It will be understood by one skilled in the art that wheel hub flange 2 could be modified to include all the features of modification unit 6, dispensing of the need for unit 6.

A control system for magnetic wheel bearing 1 will now be described. The objective of the control system for bearing 1 is to maintain electromagnetic modification unit 6 and associated wheel hub flange 2 in a desired reference position with respect to axial and radial space (x, y) by means of producing a control signal. The control should be robust enough to quickly respond despite disturbances and noise in the system. FIG. 3 shows a general block diagram for the control strategy and structure for magnetic wheel bearing 1 for one of the control axes, y, according to one example embodiment. The desired reference position is referenced as Uref and the actual sensed position is referenced as Us in the Figure. A change in displacement, y, as sensed by radial position sensor 90, with respect to the reference position will produce a response from proportional integral derivative (PID) controller 100, which will control the voltage through radial coils 110 of magnetic bearing 1, and consequently the current flow. PID controllers are known in the art and, generally calculate an error value as the difference between a measured process variable and a desired set point. The controller attempts to compensate the error by adjusting the process through use of a manipulated variable, in this case a voltage, which depends on the position of the shaft and the current through the coils of the magnetic bearing . In the case of axial position control, coils 111 would be engaged. This current will generate a change in the magnetic fluxes and therefore in the magnitude of magnetic bearing 1 forces, as a result unit 6 will be positioned to the reference coordinate.

Voltage amplifier 101 feeds magnetic bearing 1 with an appropriate voltage value depending on the PID control laws. PID 100 responds accordingly to the signal generated by the difference between the reference position with respect to the displacements measured by sensors 90, 91. The control has to be able to respond automatically to disturbances or external forces like, weight, bumps, etc. Also, it has to compensate for all the noises generated from the electronic devices.

Table 1 shows the inputs and outputs to the control system for magnetic bearing 1 control system.

TABLE 1

| INPUTS | OUTPUTS |
|---|---|
| Forces acting on the rotor: | Displacements on: |
| 1. Forces generated from the AMB (Fₘ) | 1. Sensors |
| 2. External forces (F_{d} and F_{g}) | 2. Voltage |
| 2.1 Weight | |
| 2.2 External forces (impact factor) | |

Table 2 shows one example of the control considerations for a particular magnetic wheel bearing application.

TABLE 2
Specifications

Maximum positional stiffness = 60 kN/mm
Airgap = 600 μm
Voltage = 300 V
Current = 100 A
Current stiffness = 1.02 kN/Amp
0.5 g force

An example embodiment of operation and the control states of magnetic bearing 1 will now be disclosed. In the first control state, the vehicle and magnetic bearing 1 are turned off and without power. In the second control state, the vehicle is on, but, static. During this state magnetic bearing 1 must position wheel hub flange 1 and rotor or modification unit 6 in the initial design coordinates. In the third control state, the vehicle is moving at certain speed. Wheel hub flange 2 and rotor 6 rotating and magnetic bearing 1 must keep the flange 2 and rotor 6 levitated with a constant (target) airgap, a1, a2, a3 (See FIG. 2). In the fourth control state, the vehicle is moving and suddenly is under an impact condition. The control must be able to respond relatively instantaneously (estimated response time up to 20 ms) in order to keep wheel hub flange 2 and rotor 6 levitating and without any contact with electromagnetic units 50, 51. In a fifth control state, wheel hub flange 2 is rotating but electromagnetic units 50, 51 fail or stop operating properly due to a loss of supply power. There must be a secondary power source that can relatively instantaneously supply power in case the primary source fails.

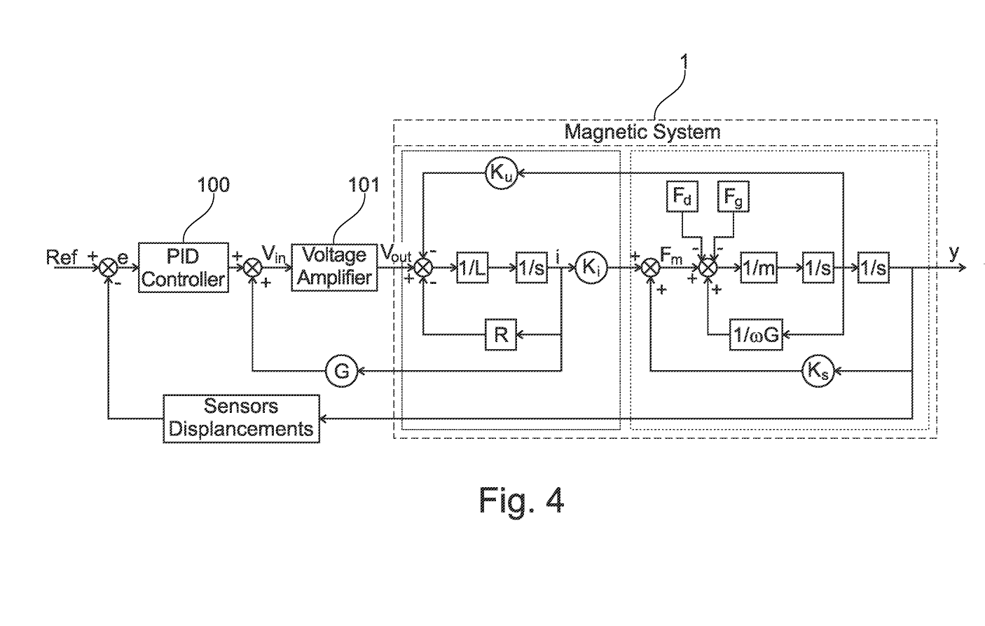

To better understand control system 200, and further define operation, as shown in FIG. 4, control system 200 can be subdivided into three subsystems: mechanical, electrical and control.

In the mechanical system, rotor 6 may be modeled by the following equation of motion, in this case for one axis:

mγ+ωGγ=Fₘ+F_{g}+F_{d}

where,
m=mass
ω=speed
G=gyroscopic force
Pₘ=mafnetic force
F_{g}=gravity force=mg
P_{α}—disturbance forces
The magnetic force is dependent on the current through the coils and the airgaps a1, a2, a3. This relationship is non-linear, however, a typical linearized implementation of such force is:

P=Kᵢi+K_{d}γ

Where Kᵢ and K_{d} are the current and position gradients in the desired operating point.

For the electrical system the voltage is dependent on the change of the position of rotor 6. This relation between position, current and voltage can be expressed as follows:

$$v = Rt + L \frac{d t}{d t} + \text{?}$$

$$\text{?} \text{indicates text missing or illegible when filed}$$

where

ν=voltage

R=reluctance

L=inductance

K_{ν}=coefficient reflecting the change in voltage with respect to the magnetic field

For the control system, magnetic bearing 1 is controlled by the implementation of PID controller 100 (baseline controller) as shown in the equation below. Depending on the results, the use of filters or optimal control can be used.

$$\text{?} = \text{?} + \frac{Nt}{s} + {K}_{d} s$$

$$\text{?} \text{indicates text missing or illegible when filed}$$

Where u(s) is the output voltage and g(s) is the error.

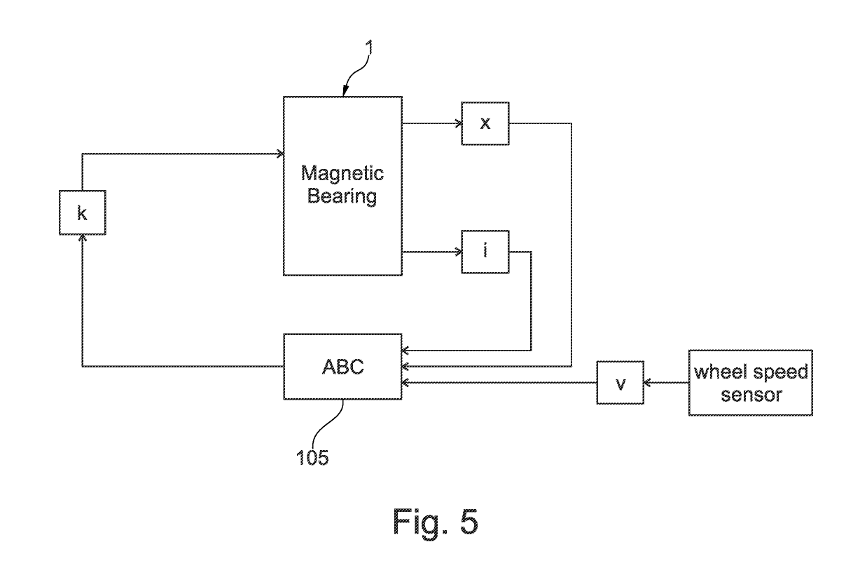

In an alternative embodiment of control and operation of magnetic wheel bearing 1, as shown in FIG. 5, a more precise Adaptive Backstepping Controller (ABC) 105 might be used to optimize centerline position x, control effort, and response time. Direct sensing might be used for position, current, and a wheel speed sensor as inputs to the controller. Vehicle speed (v) input may be used to achieve desired dynamic bearing stiffness.

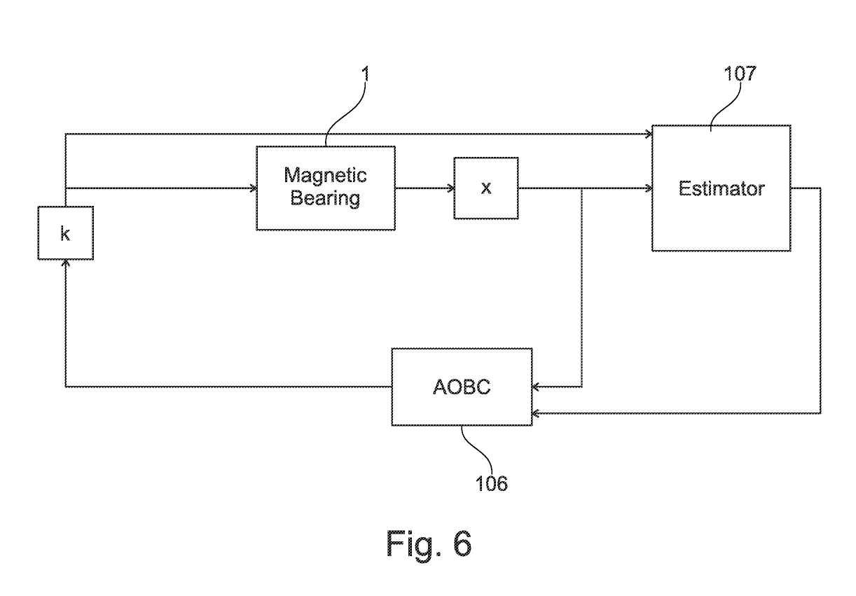

A further example embodiment is shown in FIG. 6, where ABC controller is further optimized by using established estimators with Lyapunov functions 107. Using such schema, current and voltage could be estimated as inputs to the Adaptive Observer Back steeping Controller (AOBC) 106. In such an arrangement error estimations and deviation from desired control parameter tracking could be delegated to estimator 107.

The diagram shown in FIG. 4 incorporates the three subsystems for illustrative purposes. It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A device comprising:
a wheel hub flange arranged to connect to a wheel, including;
a flange with a radial face directed toward a wheel; and
a cylindrical hub extending axially from the flange and arranged to connect to a vehicle wheel shaft;
an electromagnetic modification unit fixedly assembled onto an outer cylindrical surface of the the cylindrical hub, including;
a first axial end having a hollow cylindrical shape;
a second axial end having a hollow cylindrical shape; and
an integrally formed axial position disc extending radially outward from the second axial end and having a first and a second radial face;
an outer ring axially aligned with the electromagnetic modification unit to form a gap therebetween, including;
a first axial end axially aligned with the first axial end of the electromagnetic modification unit;
a second axial end axially aligned with the second axial end of the electromagnetic modification unit; and,
a wheel knuckle mounting feature arranged to connect to a wheel knuckle;
a first electromagnetic unit fixedly assembled at the first axial end of the outer ring and arranged to magnetically levitate the first axial end of electromagnetic modification unit in radial space; and
a second electromagnetic unit fixedly assembled at the second axial end of the outer ring, radially aligned with the axial position disc of the electromagnetic modification unit and arranged to magnetically levitate the second axial end of the electromagnetic modification unit in axial space.

2. The device of claim 1, wherein an emergency support element is axially positioned between the first and the second electromagnetic units, radially positioned between the outer ring and the electromagnetic modification unit and arranged to support the outer ring if the first or second electromagnetic units do not operate correctly.

3. The device of claim 2, wherein the emergency support element is a bearing.

4. The device of claim 1, wherein the device further includes:
at least one radial position sensor at the first axial end of the electromagnetic modification unit to sense radial position of the electromagnetic modification unit; and, at least one axial position sensor at the second axial end of the electromagnetic modification unit to sense axial position of the electromagnetic modification unit.

5. The device of claim 4, wherein the radial position sensed by the radial position sensor and the axial position sensed by the axial position sensor are used to control the first and the second electromagnetic units.
